(19) United States
(12) Patent Application Publication
(10) Pub. No.: US 2012/0148858 A1
(43) Pub. Date: Jun. 14, 2012

(54) COATING COMPOSITION FOR ALDEHYDE ABATEMENT

(75) Inventor: Shaobing Wu, Jamestown, NC (US)

(73) Assignee: Valspar Sourcing, Inc., Minneapolis, MN (US)

(21) Appl. No.: 12/965,292

(22) Filed: Dec. 10, 2010

(51) Int. Cl. B32B 21/08; B05D 3/10; C09D 133/14; C08K 3/24; C09D 163/00; C08J 7/04; B32B 23/08

(52) U.S. Cl. 428/537.1; 427/520; 427/385.5; 428/532; 428/703; 523/400; 523/402; 524/606

(57) ABSTRACT

A method includes applying an aldehyde abatement composition to a substrate to reduce at least one of the amount of an aldehyde on the substrate, the amount of an aldehyde emitted from the substrate, or the amount of an aldehyde near the substrate. The composition includes an amino-functional compound selected from: (1) compounds with a primary amino functional group and a weight average molecular weight of less than about 1000 g/mol; (2) compounds with a secondary amino functional group; (3) compounds with a tertiary amino functional group; (4) compounds with a functional group comprising an amine complex; and combinations thereof.

### BACKGROUND

Aldehyde-based resins, particularly formaldehyde-based resins, are used in binders, adhesive and coating compositions in a wide variety of building materials and wood products. For example, formaldehyde based resins are used in the manufacture of fiber and particle boards and glued products in construction materials such as panels, decking, and the like, as well as in home furnishings such as furniture, kitchen cabinetry and flooring material. For example, multi-layered parquet flooring, veneered flooring material, or plywood can emit formaldehyde through one or more of the different wood layers that are commonly bonded together by a formaldehyde-based adhesive, or the product may be coated with a formaldehyde-containing paint, stain or varnish.

Current customers prefer products such as furniture, kitchen cabinets, flooring and indoor building materials that release lower amounts of formaldehyde into the environment during manufacturing, installation or use. In addition, improved coatings are required to make wood products or building materials that can meet or exceed ever more stringent standards for formaldehyde emissions.

### SUMMARY

In one embodiment, a method includes reducing an amount of an aldehyde on or near a substrate by applying to the substrate an aldehyde abatement composition. The composition includes an amino-functional compound selected from: (1) compounds with a primary amino functional group and a weight average molecular weight of less than about 1000 g/mol; (2) compounds with a secondary amino functional group; (3) compounds with a tertiary amino functional group; (4) compounds with a functional group comprising an amine complex; and combinations thereof. The present disclosure is also directed to a coating on a substrate preparable by the method of claim 1, and this coating is particularly well suited for application to wood products and wood-based products, gypsum board, cellulose-based substrates, and the like.

In another embodiment, the present disclosure is directed to a method for reducing emission of formaldehyde from or near a substrate by applying to the substrate a composition including an amino-functional compound selected from: (1) compounds with a primary amino functional group and a weight average molecular weight of less than about 1000 g/mol; (2) compounds with a secondary amino functional group; (3) compounds with a tertiary amino functional group; (4) compounds with a functional group comprising an amine complex; and combinations thereof; and a film forming polymer.

In yet another embodiment, the disclosure is directed to a substrate having on a surface thereof a layer of a composition including an amino-functional compound selected from: (1) compounds with a primary amino functional group and a weight average molecular weight of less than about 1000 g/mol; (2) compounds with a secondary amino functional group; (3) compounds with a tertiary amino functional group; (4) compounds with a functional group comprising an amine complex; and combinations thereof.

In another embodiment, the disclosure is directed to a method including reducing the concentration of formaldehyde in ambient air proximal a substrate by applying a composition to an exposed surface of the substrate. The composition includes an amino-functional compound selected from: (1) compounds with a primary amino functional group and a weight average molecular weight of less than about 1000 g/mol; (2) compounds with a secondary amino functional group; (3) compounds with a tertiary amino functional group; (4) compounds with a functional group comprising an amine complex; and combinations thereof.

The aldehyde abatement composition described in this disclosure can reduce aldehyde emissions, and can provide a product that can be manufactured, handled and installed without special care. The compositions described herein also reduce the amount of aldehyde emitted from the product, and reduce the amount of aldehyde from an environment surrounding the product, which can result in cleaner indoor air.

The details of one or more embodiments of the invention are set forth in the accompanying description below. Other features, objects, and advantages of the invention will be apparent from the description, and from the claims.

### DETAILED DESCRIPTION

In one aspect, the present disclosure is directed to an aldehyde abatement composition, which may be applied to a substrate to reduce the amount of aldehyde emitted from the substrate or in an environment near the substrate.

In this application the term aldehyde refers to a broad class of compounds having the formula RHC═O, which are characterized by an unsaturated carbonyl group (C═O). For example, the aldehyde abatement composition is effective in removing alkylaldehydes, in which R is selected from H, a linear alkyl group, or a branched alkyl group, and is particularly well suited for removing formaldehyde (H₂C═O).

In this application the formaldehyde abatement composition may reduce the amount of aldehyde from any or all of: (1) the surface of a substrate on which the composition is applied, (2) regions underlying the substrate on which the composition is applied, or (3) the area surrounding a substrate on which the composition is applied (for example, in the air).

The aldehyde abatement composition includes an amino-functional compound having thereon at least one amino-functional group. The amino-functional compounds are selected from: (1) compounds with at least one primary amino functional group and a weight average molecular weight of less than about 1000 g/mol; (2) compounds with at least one secondary amino functional group; (3) compounds with at least one tertiary amino functional group; (4) compounds with a functional group including at least one amine complex; and combinations thereof.

Primary amino functional groups on the amino functional compound have the formula RNH₂, wherein R is alkyl or aryl. Suitable amino-functional compounds with a primary amino functional group for use in the composition include, but are not limited to, polyetheramines having at least one primary amino group attached to a polyether backbone. The polyether backbone may be based on propylene oxide (PO), ethylene oxide (EO), or mixed PO/EO. Examples of suitable polyetheramines include the monoamines, diamines and triamines available under the trade designation JEFFAMINE from Huntsman Corp., Salt Lake City, Utah, particularly the triamine JEFFAMINE T-403.

Secondary amino-functional groups on the amino functional compound have the formula RR′NH, wherein R and R′ are independently selected from alkyl or aryl. Suitable second amino-functional compounds include, but are not limited to, the diamines and triamines available under the trade designation JEFFAMINE SD and ST from Huntsman, such as SD-231, SD-401, SD-2001, and ST-404.

Tertiary amino-functional groups on the amino-functional compound have the formula RR′R″N, wherein R, R′ and R″ are independently selected from alkyl or aryl.

Suitable amino-functional compounds with a tertiary amino-functional group for use in the coating composition include those available under the trade designation DABCO from Air Products and Chemicals, Inc., Allentown, Pa., particularly DABCO BL-11. Other suitable compounds include the wide variety of tertiary amino compounds currently available for epoxy curing such as, for example JEFFAMINE D, ED and EDR.

The composition may further include an amino-functional compound having a functional group with an amine complex such as RR′R″R′″N⁺, wherein R, R′, R″ and R′″ are independently selected from H, alkyl or aryl. The amine complexes may be formed, for example, by contacting any of the above-listed primary, secondary, or tertiary amines with an amine reactive compound. This amine reactive compound may be, for example, a carbonyl functional compound, an organic compound or an inorganic compound.

The backbone of the amino-functional compound may also be selected to provide the aldehyde abatement composition with a wide range of properties for a particular application. Any polymer that is chemically compatible with the amino-functional compound may be used as a backbone in the aldehyde abatement composition, and almost any type of thermoplastic or thermosetting polymer is suitable.

For example, in some embodiments the backbone of the amino-functional compound is selected to provide film-forming properties, which can make the aldehyde abatement composition useful as a coating (e.g. a paint). For example, to provide film-forming properties, the amino-functional compound may have a backbone selected from film-forming polymers such as polyurethanes, epoxies, polyamides, polyolefins, acrylics, polyesters, and mixtures or copolymers thereof. In some embodiments, the film-forming additional polymer is an acrylic polymer or copolymer, or an epoxy. In some embodiments, the film-forming polymer may optionally be functionalized with an amine-reactive functional group such as, for example, acetoacetoxyl, epoxy, acrylate, isocyanate, and the like.

The aldehyde abatement composition may optionally include a liquid carrier, which may include an organic solvent, water, or combinations thereof. The aldehyde abatement composition may further include one or more of a group of performance enhancing additives to modify its properties for a selected application. Typical performance enhancing additives that may be employed include surface active agents, pigments, colorants, dyes, surfactants, thickeners, heat stabilizers, leveling agents, anti-cratering agents, curing indicators, plasticizers, fillers, sedimentation inhibitors, ultraviolet-light absorbers, optical brighteners, crosslinkers and the like.

The amount of the amino-functional compound in the aldehyde abatement composition is about 0.1 to about 90 wt %, preferably from about 0.5 to about 50 wt %, and more preferably from about 0.5 to about 25 wt %.

The aldehyde abatement composition may optionally include at least one additional polymer, distinct from the amino-functional compound, which is compatible with the amino-functional compound. Any additional polymer that is chemically compatible with the amino-functional compound may be used in the aldehyde abatement composition, and almost any type of thermoplastic or thermosetting polymers may be used to modify its properties for a selected end use application.

For example, in some embodiments the additional polymer can be selected to enhance reactivity with an aldehyde, or the amino-functional compound can enhance the reactivity of the additional polymer toward aldehydes.

For example, in some embodiments, an acetoacetyl-functional compound or polymer is added to the aldehyde abatement composition to provide additional reactivity with an aldehyde and reduction of aldehydes in the environment near the substrate on which the composition is applied. For example, a compound or polymer with an acetoacetyl-functional group:

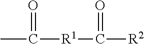

wherein R¹ is a C1 to C22 alkylene group and R² is a C1 to C22 alkyl group, and preferably wherein R¹ is a C1 to C4 alkylene group and R² is a C1 to C4 alkyl group, and more preferably, R¹ is methylene (—CH₂—) and R² is methyl (—CH₃), can be added to or placed in solution with the composition with the primary, secondary or tertiary amino-functional compound. While not wishing to be bound by any theory, presently available evidence suggests that the amino functional groups on the amino-functional compound react with the acetoacetyl functional group to enhance the reactivity of the acetoacetyl functional group toward aldehydes.

In other embodiments, the additional polymer can provide or enhance the film-forming properties of the composition. For example, suitable film-forming additional polymers may include, but are not limited to, polyurethanes, epoxies, polyamides, polyolefins, acrylics, polyesters, polyethers, and mixtures or copolymers thereof. In some embodiments, the film-forming additional polymer is an acrylic polymer or copolymer, or an epoxy. In some embodiments, the film-forming polymer may optionally be functionalized with an amine-reactive functional group such as, for example, acetoacetoxyl, epoxy, acrylate, isocyanate, and the like.

For example, in some embodiments the film-forming additional polymer may have an acetoacetyl-functional group, which provides film-forming properties and makes the aldehyde abatement composition suitable as a coating (e.g. a paint). As discussed above, the amines on the amino-functional compound can react with the acetoacetyl functional groups on the additional polymer to make the acetoacetyl functional groups more reactive toward aldehydes.

For example, to form a suitable coating, the aldehyde abatement composition can be solventborne, and includes the film-forming additional polymer, the amino-functional compound, a suitable solvent or combination of solvents, and appropriate additives. To form a suitable solventborne coating, the amount of the film-forming additional polymer in the solventborne aldehyde abatement composition is suitably from about 5 to about 95 weight %, preferably from about 20 to about 80 weight %, and more preferably from about 30 to about 70 weight %. The amount of solvent in the solventborne coating aldehyde abatement composition is about 10% to about 90% by weight, more preferably about 20 to about 80% by weight.

Useful solvents for the solventborne aldehyde abatement coating composition include, but are not limited to, ketones, esters, aromatics, methyl ethyl ketone (MEK), butyl acetate and combinations thereof.

In some embodiments, the aldehyde abatement composition may be formulated as a waterborne coating, and includes a water-dispersible or a latex additional polymer, an amino-functional compound, water, an optional solvent or combination of solvents, and appropriate additives. For example, in certain embodiments, the additional polymer is an acetoacetyl-functional latex polymer with a particle size of from about 50 to about 500 nm. Preferably, the acetoacetyl-functional latex polymer includes latex particles having an average particle size (i.e., the average of the longest dimension of the particles, typically, a diameter) of less than 75 nm as measured by a Coulter N4 Plus.

The waterborne aldehyde abatement coating compositions preferably include about 40 wt % to about 90 wt % water, more preferably about 40 wt % to about 70 wt % water, based on the total weight of the composition.

Some embodiments of the waterborne aldehyde abatement coating compositions have a relatively low volatile organic content (VOC), which in this application means the composition includes no more than about 60 wt %, preferably no more than 40 wt % volatile organic compounds, based on the total weight of the composition. The term volatile organic compound is defined in U.S. Pat. No. 6,048,471 (Henry) and in the U.S. Federal Register: Jun. 16, 1995, volume 60, number 111.

In another embodiment, the aldehyde abatement coating compositions may include an ethylenically unsaturated compound, distinct from the film-forming additional polymer and the amino-functional compound, to modify the properties of the coating composition. These ethylenically unsaturated compounds may optionally be multifunctional (i.e., include two or more ethylenically unsaturated groups), which makes them suitable crosslinkable diluents. Such compounds may be monomers, oligomers, polymers, or mixtures thereof. The ethylenically unsaturated compounds are preferably (meth)acrylate monomers, more preferably (meth)acrylate monomers with two or more (meth)acrylate groups (i.e., they are multifunctional).

The optional ethylenically unsaturated compound may be present in the aldehyde abatement coating composition in an amount of at least 5 wt %, more preferably in an amount of at least 7.5 wt %, and even more preferably in an amount of at least 10 wt %, based on the combined weight of the ethylenically unsaturated compound and the additional polymer in the composition. The aldehyde abatement coating compositions preferably include an ethylenically unsaturated compound in an amount of no more than 70 wt %, more preferably in an amount of no more than 50 wt %, and even more preferably in an amount of no more than 40 wt %, based on the combined weight of the ethylenically unsaturated compound and the film-forming additional polymer component of the composition.

Other components of the aldehyde abatement coating compositions include those typically used in paint formulations, such as pigments, fillers, thickeners, biocides, mildewcides, surfactants, dispersants, defoamers, and the like. Suitable additives for use in coating compositions of the present invention are described in Koleske et al., Paint and Coatings Industry, April, 2003, pages 12-86.

In some embodiments, the waterborne aldehyde abatement coating compositions including a latex polymer also include surface active ingredients, such as a nonionic or anionic surfactant. Such surfactants not only create a dispersion or emulsion of polymer particles in water, but assist incorporation of the optional ethylenically unsaturated compound.

The aldehyde abatement coating compositions may also include one or more of a group of ingredients that can be called performance enhancing additives. Typical performance enhancing additives that may be employed include surface active agents, pigments, colorants, dyes, surfactants, thickeners, heat stabilizers, leveling agents, anti-cratering agents, curing indicators, plasticizers, fillers, sedimentation inhibitors, ultraviolet-light absorbers, optical brighteners, and the like to modify properties.

The aldehyde abatement compositions may include a surface-active agent that modifies the interaction of the curable coating composition with the substrate, in particular, the agent can modify the ability of the composition to wet a substrate. Surface active agents may have other properties as well. For example, surface active agents may also include leveling, defoaming, or flow agents, and the like. If the aldehyde abatement composition has properties of a curable coating composition, the surface active agent can also affect qualities of the curable coating composition including, for example, how the coating composition is handled, how it spreads across the surface of a substrate to which it is applied, and how it bonds to the substrate. If it is used, the surface active agent is preferably present in an amount of no greater than 5 wt %, based on the total weight of the composition.

Surface active agents have also been found to assist incorporation as well as assist in the formulation of the aldehyde abatement coating compositions. Suitable surface active agents include, but are not limited to, polydimethylsiloxane surface active agents (such as those commercially available under the trade designations SILWET L-760 and SILWET L-7622 from OSI Specialties, South Charleston, W. Va., or BYK 306, BYK 333, and BYK 346 from Byk-Chemie, Wallingford, Conn.) and fluorinated surface active agents (such as that commercially available as FLUORAD FC-430 from 3M Co., St. Paul, Minn.).

The surface active agents may include a defoamer. Suitable defoamers include polysiloxane defoamers (such as a methylalkylpolysiloxane like that commercially available under the trade designation BYK 077 or BYK 500 from Byk-Chemie) or polymeric defoamers (such as that commercially available under the trade designation BYK 051 from Byk-Chemie).

For some applications, a coating that is opaque, colored, pigmented or has other visual characteristics is desired. Agents to provide such properties can also be included in the aldehyde abatement coating compositions. Pigments for use in the coating compositions include, but are not limited to, titanium dioxide white, carbon black, lampblack, black iron oxide, red iron oxide, yellow iron oxide, brown iron oxide (a blend of red and yellow oxide with black), phthalocyanine green, phthalocyanine blue, organic reds (such as naphthol red, quinacridone red and toulidine red), quinacridone magenta, quinacridone violet, DNA orange, and/or organic yellows (such as Hansa yellow). The composition can also include a gloss control additive or an optical brightener, such as that commercially available under the trade designation UVITEX OB from Ciba-Geigy.

In certain embodiments it can be advantageous to include fillers or inert ingredients in the aldehyde abatement coating composition. Fillers and inert ingredients include, for example, clay, glass beads, calcium carbonate, talc, silicas, organic fillers, and the like. Fillers extend, lower the cost of, alter the appearance of, or provide desirable characteristics to the composition before and after it is dried. Suitable fillers are known to those of skill in the art or can be determined using standard methods. Fillers or inert ingredients are preferably present in an amount of at least 0.1 wt %, based on the total weight of the composition. Fillers or inert ingredients are preferably present in an amount of no greater than 40 wt %, based on the total weight of the composition.

The aldehyde abatement coating composition may also include other ingredients that modify properties of the composition as it is stored, handled, or applied, and at other or subsequent stages. Waxes, flatting agents, mar and abrasion additives, and other similar performance enhancing additives may be employed in amounts effective to upgrade the performance of the composition and any dried coating based on the composition. Desirable performance characteristics of the coating include chemical resistance, abrasion resistance, hardness, gloss, reflectivity, appearance, or combinations of these characteristics, and other similar characteristics.

In certain embodiments, the aldehyde abatement coating composition may be radiation-curable. For example, in certain preferred embodiments, the composition is aqueous-based and ultraviolet (“UV”) radiation-curable, and includes an acetoacetyl-functional film-forming polymer, an acrylate or methacrylate functional (preferably, multifunctional) compound distinct from the film-forming polymer, an amine functional compound, and a photoinitiator.

These radiation curable coating compositions typically include a free-radical initiator, particularly a photoinitiator that induces the curing reaction upon exposure to light. The photoinitiator is preferably present in an amount of at least 0.1 wt %, based on the total weight of the composition. The photoinitiator is preferably present in an amount of no greater than 10 wt %, based on the total weight of the composition.

Among photoinitiators suitable for use in the compositions with additional resins having (meth)acrylate functional groups are alpha-cleavage type photoinitiators and hydrogen abstraction-type photoinitiators. The photoinitiator may include other agents such as a coinitiator or photoinitiator synergist that aid the photochemical initiation reaction. Suitable cleavage type photoinitiators include alpha, alpha-diethoxyacetophenone (DEAP), dimethoxyphenylacetophenone (commercially available under the trade designation IRGACURE 651 from Ciba Corp., Ardsley, N.Y.), hydroxycyclo-hexylphenylketone (commercially available under the trade designation IRGACURE 184 from Ciba Corp.), 2-hydroxy-2-methyl-1-phenylpropan-1-one (commercially available under the trade designation DAROCUR 1173 from Ciba Corp.), a 25:75 blend of bis-(2,6-dimethoxybenzoyl)-2,4,4-trimethylpentyl phosphine oxide and 2-hydroxy-2-methyl-1-phenylpropan-1-one (commercially available under the trade designation IRGACURE 1700 from Ciba Corp.), a 50:50 blend of 2-hydroxy-2-methyl-1-phenylpropan-1-one and 2,4,6-trimethylbenzoyl-diphenylphosphine oxide (TPO, commercially available under the trade designation DAROCUR 4265 from Ciba Corp.), phosphine oxide, 2,4,6-trimethyl benzoyl (commercially available under the trade name IRGACURE 819 and IRGACURE 819DW from Ciba Corp.), 2,4,6-trimethylbenzoyl-diphenylphosphine oxide (commercially available under the trade designation LUCIRIN from BASF Corp., Mount Olive, N.J.), and a mixture of 70% oligo 2-hydroxy-2-methyl-4-(1-methylvinyl)phenylpropan-1-one and 30% 2-hydroxy-2-methyl-1-phenylpropan-1-one) (commercially available under the trade designation KIP 100 from Sartomer, Exton, Pa.). Suitable hydrogen abstraction-type photoinitiators include benzophenone, substituted benzophenones (such as that commercially available under the trade designation ESCACURE TZT from Fratelli-Lamberti, sold by Sartomer, Exton, Pa.), and other diaryl ketones such as xanthones, thioxanthones, Michler's ketone, benzil, quinones, and substituted derivatives of all of the above. Preferred photoinitiators include DAROCUR 1173, KIP 100, benzophenone, and IRGACURE 184. A particularly preferred initiator mixture is commercially available under the trade designation IRGACURE 500 from Ciba Corp., which is a mixture of IRGACURE 184 and benzophenone, in a 1:1 ratio. This is a good example of a mixture of an alpha-cleavage type photoinitiator and a hydrogen abstraction-type photoinitiator. Other mixtures of photoinitiators may also be used in the coating compositions of the present invention. Camphorquinone is one example of a suitable photoinitiator for curing a coating composition with visible light.

The compositions can also include a coinitiator or photoinitiator synergist. The coinitiators can be tertiary aliphatic amines (such as methyl diethanol amine and triethanol amine), aromatic amines (such as amylparadimethylaminobenzoate, 2-n-butoxyethyl-4-(dimethylamino)benzoate, 2-(dimethylamino)ethylbenzoate, ethyl-4-(dimethylamino)benzoate, and 2-ethylhexyl-4-(dimethylamino)benzoate, (meth)acrylated amines (such as those commercially available under the trade designations EBECRYL 7100 and UVECRYL P104 and P115, all from UCB RadCure Specialties, Smyrna, Ga.), and amino-functional acrylate or methacrylate resin or oligomer blends (such as those commercially available under the trade designations EBECRYL 3600 or EBECRYL 3703, both from UCB RadCure Specialties). Combinations of the above categories of compounds may also be used.

Preferred photoinitiators include benzophenone, 4-methylbenzophenone, benzoyl benzoate, phenylacetophenones, 2,2-dimethoxy-2-phenylacetophenone, alpha,alpha-diethoxyacetophenone, hydroxycyclo-hexylphenylketone, 2-hydroxy-2-methyl-1-phenylpropan-1-one, bis-(2,6-dimethoxybenzoyl)-2,4,4-trimethylpentyl phosphine oxide, 2-hydroxy-2-methyl-1-phenylpropan-1-one, 2-hydroxy-2-methyl-1-phenylpropan-1-one, 2,4,6-trimethylbenzoyl-diphenylphosphine oxide, and combinations thereof.

Preferred coating compositions include a free radical initiator that is a hydrogen abstraction-type photoinitiator. Preferably, the hydrogen abstraction-type photoinitiator is benzophenone or a 4-methylbenzophenone. Such compositions are at least partially curable by ultraviolet light.

The amount of hydrogen abstraction-type photoinitiator in such a coating composition is preferably at least 0.1 wt %, more preferably at least 0.2 wt %, and even more preferably at least 0.4 wt %, based upon the total weight of the composition. The amount of hydrogen abstraction-type photoinitiator in such a composition is preferably no more than 4 wt %, more preferably no more than 3 wt %, and even more preferably no more than 2 wt %, based upon the total weight of the composition.

Coating compositions having resins with vinyl ether functional groups can be cured by UV or visible light using cationic-generating photoinitiators. Examples of suitable cationic-generating photoinitiators include super acid-generating photoinitiators, such as triarylsulfonium salts like triphenyl sulfonium hexafluorophosphate.

Compositions that include compounds with (meth)acrylate and/or allyl functional groups may also be thermally cured using a suitable initiator. The thermal initiator typically facilitates the curing process by a free radical mechanism and typically includes a peroxide or azo compound. Peroxide compounds suitable for use as initiators in the coating compositions of the present invention include t-butyl perbenzoate, t-amyl perbenzoate, cumene hydroperoxide, t-amyl peroctoate, methyl ethyl ketone peroxide, benzoyl peroxide, cyclohexanone peroxide, 2,4-pentanedione peroxide, di-t-butyl peroxide, t-butyl hydroperoxide, and di-(2-ethylhexyl)-peroxydicarbonate. Suitable azo compounds which may be employed as an initiator in the present compositions include 2,2-azo bis-(2,4-dimethylpentane-nitrile), 2,2-azo bis-(2-methylbutanenitrile), and 2,2-azo bis-(2-methylpropanenitrile).

Other methods for curing the compositions can be used alone or in combination with methods described above. Supplemental curing methods include heat cure, chemical cure, anaerobic cure, moisture cure, oxidative cure, and the like. Each method of cure requires a corresponding curing initiator or curing agent, which is included in the composition. For example, thermal cure can be induced by peroxides, metal drier packages can induce an oxidative cure, multifunctional amines (for example isophorone diamine) can cause a chemical crosslinking cure through Michael addition of amine groups onto acrylate reactive unsaturated groups. If these additional initiators are present in the composition they are preferably present in an amount of at least 0.1 wt %, based on the weight of the coating composition. Preferably, they are present in an amount of no greater than 12 wt %, based on the weight of the composition. Means for effecting cures by such methods are known to those of skill in the art or can be determined using standard methods.

Preferred coatings are cured by exposing the composition to radiation having a wavelength in the range of 10⁻³ nm to 800 nm. More preferably, the compositions are exposed to ultraviolet or visible light in the range of 200 nm to 800 nm. The compositions may also be cured by thermal means or other forms of radiation such as, for example, electron beam.

Preferred coatings, which are designed to be cured by ultraviolet or visible light, are preferably exposed to 100 Mjoules/cm² to 5000 Mjoules/cm², more preferably exposed to 300 Mjoules/cm² to 2000 Mjoules/cm², and even more preferably exposed to 500 Mjoules/cm² to 1750 Mjoules/cm².

In another embodiment, the present disclosure is directed to a method of treating a substrate with the formaldehyde abatement composition to reduce the presence of an alkyaldehyde, particularly formaldehyde, from the substrate itself, from a coating layer or adhesive applied on the substrate, or from the environment surrounding the substrate.

The aldhehyde abatement compositions may be applied to any substrate, but have been found to be particularly well suited to reduce the amount of measurable aldehyde on wood, wood-based products, cement, cement fiber board, wood-plastic composites, gypsum board, tile, metal, plastic, glass, optical fibers, and fiberglass. The aldehyde abatement compositions can be applied to a substrate by a variety of methods known to those skilled in the art, such as spraying, painting, rollcoating, brushing, fan coating, curtain coating, spreading, air knife coating, die-coating, vacuum coating, spin coating, electrodeposition, and dipping. The aldehyde abatement composition may be applied directly on an exposed surface of a substrate and/or may also be applied to an interior panel beneath the substrate.

For example, a wood based product includes at least one layer formed from wood chips, wood flakes, or wood fibers and held together by an adhesive, and the constituent layers of the product may also be held together by an adhesive. The aldehyde abatement composition may be applied directly on an exposed surface layer of the wood based product, on an edge, or on an interior layer of the wood based product. The aldehyde abatement composition removes aldehyde emitted from the surface layer of the wood based product itself, from other coatings applied on the wood-based product, from layers of the wood-based product below the surface, from adhesives applied to the wood-based product, and from the air surrounding the wood-based product.

To effectively remove an aldehyde from a substrate, the aldehyde abatement composition should preferably be applied in an amount from about 0.1 to about 250 g/m², preferably from about 0.5 to about 200 g/m², most preferably from about 2 to about 100 g/m². The suitable upper limit depends on which type of wood product or wood based product to which the composition is applied.

In another embodiment, the present disclosure is directed to a method in which the aldehyde abatement composition is applied to a substrate and at least partially dried to form an aldehyde reducing coating on the substrate. As noted above, wood products or wood-based product are particularly useful substrates, but this application is not limited to substrates including wood.

In yet another embodiment, the present disclosure is directed to a coating obtained or obtainable from the aldehyde abatement composition. After the composition is dried, the dry thickness of the resulting aldehyde-reducing coatings will vary with the application. The coatings typically have a thickness of 0.1 mil to 20 mils (0.00025 centimeter (cm) to 0.0508 cm), but thicker or thinner coatings are also contemplated depending on, for example, the desired coating properties or the potential amount of formaldehyde to be removed.

In yet another embodiment, the present disclosure is directed to a method in which the aldehyde abatement composition is applied to a substrate, or to another coating layer on the substrate, to reduce the amount of an aldehyde (particularly formaldehyde) in the environment near the substrate. For example, the coating composition may reduce the amount of formaldehyde in the air near the substrate. In one embodiment, the aldehyde abatement composition may be applied to a wood product or a wood-based product to reduce formaldehyde from the air surrounding the product. In some embodiments, the amount of formaldehyde in the air near the product is reduced to less than 0.05 ppm.

The following examples are offered to aid in understanding of the present invention and are not to be construed as limiting the scope thereof. Unless otherwise indicated, all parts and percentages are by weight.

### EXAMPLES

### 1. Formula Preparation

All the formulas (200 g) in Tables 1 to 4 below were prepared by weighing and adding the ingredients into a metal container with a cover in the order as listed under agitation and filtered with a 50 μm filter for application.

### 2. Coating Samples for Testing Abating Formaldehyde from a Coating/Substrate Emitting Formaldehyde and Preparation Thereof

To obtain a viable test to determine reduction in formaldehyde (HCHO) emission from a coating/substrate, a coating film with free HCHO and cure emitted HCHO was first drawn down on glass plate (one sq ft) using a 3 mil wire rod and dried at an ambient temperature for 15 minutes.

Next, the coating film was cured by placing the sample into an air forced oven (50° C.) for 30 minutes. After curing the HCHO emitting coating film, the sample was cooled at room temperature for one hour before applying a HCHO abatement coating/treatment.

A formaldehyde abatement coating/treatment composition or a control against HCHO emitting coating was applied, dried and cured under the same conditions as the first coat.

After the final curing from the oven, the sample was allowed to be cooled at a room temperature for one hour before loading into the environmental chambers for the emission testing.

### 3. Coating Samples for Testing Abating Formaldehyde from Air Containing Formaldehyde

To obtain a viable test to determine reduction in HCHO emission from air, a formaldehyde abatement coating/treatment composition was drawn down on glass plate (one sq ft) using a wire rod (5 mil for waterborne and 3 mil for solvent borne) and dried at ambient temperature for 15 minutes. Then, it was cured by placing the sample into an air forced oven (50° C.) for 30 minutes.

After the final curing from the oven, the sample was cooled at a room temperature for one hour before loading into the environmental chambers for the emission testing.

A formaldehyde water solution (0.153 wt %) was prepared using a 37 wt % formaldehyde water solution, analytical grade from Fisher Scientific and diluted with de-ionized water. Then, 30 grams of the solution was weighed into an 8 oz jar and used as a formaldehyde emitting source to air in the chambers.

### 4. Formaldehyde Emission Testing

1) Environmental Chambers and Formaldehyde Emission Measurement

The environmental chambers (0.05 m³) used in the testing were prepared and supplied by Arcadis Inc, Cary, N.C. according to ASTM Standards D5116 and D6670. The chambers were operated under conditions of 24° C. and 50% humidity with one air change per hour. The air flow from the chambers was allowed to pass through a Waters SEP-PAK DNPH-SILICA Cartridge to retain any formaldehyde in the air.

2) Formaldehyde Analysis

The formaldehyde in the SEP PAK was analyzed using a HPLC according to ASTM E411 “Standard test method for trace quantities of carbonyl compounds with 2,3-dinitrophenylhydrazine.”

### Formulas and Reagents

Setalux 17-450—amine-functional acrylic resin, Nuplex Industries, Ltd., Auckland, NZ
Setalux 27-1435—epoxy-functional acrylic resin, Nuplex Industries, Ltd., Auckland, NZ
Joncryl 587—hydroxyl functional acrylic polyol, BASF, Florham Park, N.J.
MEK—methyl ethyl ketone
BYK 300—surface active agent, Byk-Chemie GmbH, Wesel, Germany
BYK 346—surface active agent, Byk-Chemie GmbH, Wesel, Germany
BYK 024—surface active agent, Byk-Chemie GmbH, Wesel, Germany
Acrysol RM825—rheology modifier, Rohm and Haas, Philadelphia, Pa.
Jeffamine T-403—polyethertriamine, Huntsman Corp., Salt Lake City, Utah DABCO BL-11—tertiary amino functional compound, Air Products and Chemicals, Inc., Allentown, Pa.
Valspar 6946-045—AAEM functional acrylic latex made according to exemplary procedure set forth in U.S. Pat. No. 7,812,090

TABLE 1
Solventborne formaldehyde abatement coatings/treatments based on acetoacetyl (AA)
functional resin as a function of primary amine concentration against non-AA
functional resin

| | N01 | N02 | N03 | N04 | J01 | J02 | J03 | J04 |
|---|---|---|---|---|---|---|---|---|
| Setalux 17-1450 | 46.15 | 38.77 | 40.92 | 42.92 | 0 | 0 | 0 | 0 |
| Joncryl 587 | 0 | 0 | 0 | 0 | 30 | 25.2 | 26.6 | 27.9 |
| MEK | 26.82 | 28.11 | 27.74 | 27.39 | 34.9 | 34.9 | 34.9 | 34.9 |
| Butyl acetate | 26.83 | 28.11 | 27.74 | 27.39 | 34.9 | 34.9 | 34.9 | 34.9 |
| BYK 300 | 0.2 | 0.2 | 0.2 | 0.2 | 0.2 | 0.2 | 0.2 | 0.2 |
| Jeffamine | 0 | 4.8 | 3.4 | 2.1 | 0 | 4.8 | 3.4 | 2.1 |
| T403 | | | | | | | | |
| total | 100 | 100 | 100 | 100 | 100 | 100 | 100 | 100 |

TABLE 2
Solventborne formaldehyde abatement coatings/treatments based on epoxy
resin

| | N05 | N06 | N07 |
|---|---|---|---|
| Setalux 27-1435 | 27.44 | 30.13 | 33.38 |
| MEK | 32.15 | 31.88 | 31.56 |
| Butyl acetate | 32.16 | 31.89 | 31.56 |
| BYK 300 | 0.2 | 0.2 | 0.2 |
| Jeffamine T403 | 8.05 | 5.9 | 3.3 |
| DABCO BL-11 | 0 | 0 | 0 |
| total | 100 | 100 | 100 |

TABLE 3
Waterborne formaldehyde abatement coating/treatment as function of
amines

| | NJ01 | NJ02 | NJ03 |
|---|---|---|---|
| 6946-045 (AAEM | 72.25 | 67.78 | |
| functional acrylic latex) | | | |
| water | 10 | 10 | |
| dipropylene methyl | 3 | 3 | |
| ether | | | |
| dipropylene butyl ether | 2 | 2 | |
| surfynol 104BC | 0.2 | 0.2 | |
| Byk346 | 0.3 | 0.3 | |
| water | 5.0 | 5.0 | |
| MEK | 0 | 0 | |
| Byk024 | 0.1 | 0.1 | |
| Acrysol RM825 | 0.2 | 0.2 | |
| water | 5.35 | 8.52 | |
| Jeffamine T403 | 0 | 2.9 | |
| DABCO BL-11 | 1.6 | 0 | |
| NJ02 | | | 50 |
| Valspar Ultra Premium | | | 50 |
| Interior Ceiling Paint | | | |
| total | 100 | 100 | 100 |

TABLE 4
Solventborne formaldehyde abatement coatings/treatments as a functional
of tertiary amine concentrations

| | N08 | N09 | N10 | J05 | J06 | J07 |
|---|---|---|---|---|---|---|
| Setalux 17- | 41.74 | 43.14 | 44.86 | 0 | 0 | 0 |
| 1450 | | | | | | |
| Joncryl 587 | 0 | 0 | 0 | 27.13 | 28.04 | 29.16 |
| MEK | 23.02 | 26.93 | 26.87 | 34.28 | 34.48 | 34.72 |
| Butyl acetate | 23.02 | 26.93 | 26.87 | 34.29 | 34.48 | 34.72 |
| BYK 300 | 0.2 | 0.2 | 0.2 | 0.2 | 0.2 | 0.2 |
| DABCO BL-11 | 4.1 | 2.8 | 1.2 | 4.1 | 2.8 | 1.2 |
| total | 100 | 100 | 100 | 100 | 100 | 100 |

TABLE 5
Formaldehyde solution

| | FS01 |
|---|---|
| 37 wt % | 0.4135 |
| Formaldehyde | |
| water solution | |
| from Fisher | |
| Scientific | |
| De-ionized | 99.5865 |
| water | |
| total | 100.00 |

TABLE 6
Commercial products

| | AUF4404/ | TAF0006/ | | |
|---|---|---|---|---|
| | CXC4000 | CXC7004 | KPC3448 | LTF0116 |
| Description | Valspar acid | Valspar | Valspar 100% | Valspar |
| | catalyzed | polyurethane | UV coating | waterborne |
| | conversion | coating | | UV coating |
| | varnish | | | |
| Solids, wt % | 37.6/57.0 | 35.0/32.4 | 100.0 | 37.1 |
| Mixing ratio | AUF4404/ | TAF0006/ | NA | NA |
| | CXC4000 | CXC7004 | | |
| | at 100/3.5 | at 2/1 | | |

### Formaldehyde Emission Results:

TABLE 7
Formaldehyde emission* from non-formaldehyde absorbing control coatings as a
function of time

| sample | S01 | S02 | S03 | S04 | S05 | S06 |
|---|---|---|---|---|---|---|
| 1^{st} coat | AUF4404/ | AUF4404/ | AUF4404/ | AUF4404/ | AUF4404/ | AUF4404/ |
| | CXC4000 | CXC4000 | CXC4000 | CXC4000 | CXC4000 | CXC4000 |
| 2^{nd} coat | NA | N01 | J01 | TAF0006/ | KPC3448 | LTF0116 |
| | | | | CXC7004 | | |
| Amine % | 0 | 0 | 0 | 0 | 0 | 0 |
| Substrate | glass | glass | glass | glass | glass | glass |
| 24 hrs | 213 | 97 | 68 | 68 | 61 | 85 |
| 72 hrs | 104 | 74 | 57 | 47 | 41 | 52 |
| 168 hrs | 65 | 59 | 39 | 36 | 32 | 33 |

*All data denoted in “μg (micrograms) of formaldehyde/hr sampling unless specified”

TABLE 8
Formaldehyde emission from coatings based on AA functional resin against non-AA
functional resins as a function of primary amine concentrations and time

| | S07 | S08 | S09 | S10 | S11 | S12 |
|---|---|---|---|---|---|---|
| 1^{st} coat | AUF4404/ | AUF4404/ | AUF4404/ | AUF4404/ | AUF4404/ | AUF4404/ |
| | CXC4000 | CXC4000 | CXC4000 | CXC4000 | CXC4000 | CXC4000 |
| 2^{nd} coat | N02 | N03 | N04 | J02 | J03 | J04 |
| Amine % | 4.8 | 3.4 | 2.1 | 4.8 | 3.4 | 2.1 |
| Substrate | glass | glass | glass | glass | glass | glass |
| 24 hrs | 1.8 | 9.5 | 19 | 2.2 | 5.2 | 23 |
| 72 hrs | 2.1 | 10.3 | 29 | 2.4 | 6.4 | 22 |
| 168 hrs | 1.9 | 11 | 33 | 3.1 | 5.8 | 27 |

TABLE 9
Formaldehyde emission from coatings based on epoxy resin as a function
of primary amine concentrations and time

| | S13 | S14 | S15 |
|---|---|---|---|
| 1^{st} coat | AUF4404/ | AUF4404/ | AUF4404/ |
| | CXC4000 | CXC4000 | CXC4000 |
| 2^{nd} coat | N05 | N06 | N07 |
| Amine % | 8.05 | 5.9 | 3.3 |
| Substrate | glass | glass | glass |
| 24 hrs | 1.0 | 1.6 | 10 |
| 72 hrs | 1.1 | 1.8 | 25 |
| 168 hrs | 1.2 | 2.5 | 30 |

TABLE 10
Formaldehyde emission from coatings as a function of tertiary amine concentrations
and time

| | S16 | S17 | S18 | S19 | S20 | S21 |
|---|---|---|---|---|---|---|
| 1^{st} coat | AUF4404/ | AUF4404/ | AUF4404/ | AUF4404/ | AUF4404/ | AUF4404/ |
| | CXC4000 | CXC4000 | CXC4000 | CXC4000 | CXC4000 | CXC4000 |
| 2^{nd} coat | N08 | N09 | N10 | J05 | J06 | J07 |
| Amine % | 4.1 | 2.8 | 1.2 | 4.1 | 2.8 | 1.2 |
| Substrate | glass | glass | glass | glass | glass | glass |
| 24 hrs | 0.22 | 0.38 | 4.5 | 27 | 45 | 52 |
| 72 hrs | 0.24 | 0.39 | 4.8 | 25 | 39 | 45 |
| 168 hrs | 0.25 | 0.33 | 5.2 | 21 | 27 | 32 |

TABLE 11
Formaldehyde emission from waterborne coatings as a function of time

| | S22 | S23 |
|---|---|---|
| 1^{st} coat | AUF4404/ | AUF4404/ |
| | CXC4000 | CXC4000 |
| 2^{nd} coat | NJ01 | NJ02 |
| Amine % | 1.6 | 2.9 |
| Substrate | glass | glass |
| 24 hrs | 2.4 | 12.5 |
| 72 hrs | 3.0 | 14.3 |
| 168 hrs | 2.8 | 13.6 |

TABLE 12
Formaldehyde emitted from wood sample and coating treatment

| | S24 | S25 | S26 | S27 |
|---|---|---|---|---|
| Commercial wood | door skin | door skin | Office | |
| substrate | | | furniture | |
| | | | particle board | |
| HCHO absorption | NA | NJ02 at 3 | NA | NJ02 at 3 |
| coating | | mils wet | | |
| 4 hrs | 2.38 μg/sq | 0.21 μg/sq | 14.46 μg/sq | 0.50 μg/sq |
| | ft * hour | ft * hour | ft * hour | ft * hour |

TABLE 13
Formaldehyde emitted from formaldehyde water solution with or without
formaldehyde abating coating

| | FS01 | NJ02 | NJ03 | N02 |
|---|---|---|---|---|
| 8 hur | 79.37 | 24.53 | 38.53 | 46.48 |
| 24 hrs | 77.75 | 35.47 | 51.45 | 46.24 |
| 72 hrs | 79.33 | 54.03 | 64.89 | 49.96 |
| 168 hrs | 81.21 | 69.68 | 75.41 | 56.97 |

Various embodiments of the invention have been described. These and other embodiments are within the scope of the following claims.

1. A method, comprising:
reducing an amount of an aldehyde on or near a substrate by applying to the substrate an aldehyde abatement composition, wherein the composition comprises an amino-functional compound selected from: (1) compounds with a primary amino functional group and a weight average molecular weight of less than about 1000 g/mol; (2) compounds with a secondary amino functional group; (3) compounds with a tertiary amino functional group; (4) compounds with a functional group comprising an amine complex; and combinations thereof.

2. The method of claim 1, wherein the amino-functional compound is a polyetheramine having at least one primary amino group attached to a polyether backbone.

3. The method of claim 1, wherein the composition further comprises a liquid carrier.

4. The method of claim 1, wherein the amino-functional compound comprises a backbone comprising a film-forming polymer selected from polyurethanes, epoxies, polyamides, polyether, polyethylene oxide, polyolefins, acrylics, polyesters, and mixtures or copolymers thereof.

5. The method of claim 4, wherein the film-forming polymer comprises an acrylic polymer or copolymer.

6. The method of claim 1, wherein the aldehyde abatement composition further comprises a compound with an acetoacetyl functional group of the formula: 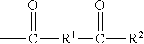
wherein R¹ is a C1 to C22 alkylene group and R² is a C1 to C22 alkyl group.

7. The method of claim 6, wherein R¹ is a C1 to C4 alkylene group and R² is a C1 to C4 alkyl group.

8. The method of claim 6, wherein R¹ is methylene (—CH₂—) and R² is methyl (—CH₃).

9. The method of claim 1, wherein the composition further comprises a film-forming polymer selected from polyurethanes, epoxies, polyamides, polyolefins, acrylics, polyesters, polyvinyls, polyethers, alkyds, nitrocellulose, and mixtures or copolymers thereof.

10. The method of claim 9, wherein the film-forming polymer comprises an acetoacetyl functional group of the formula: 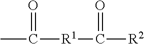
wherein R¹ is a C1 to C22 alkylene group and R² is a C1 to C22 alkyl group.

11. The method of claim 10, wherein R¹ is a C1 to C4 alkylene group and R² is a C1 to C4 alkyl group.

12. The method of claim 10, wherein R¹ is methylene (—CH₂—) and R² is methyl (—CH₃).

13. The method of claim 9, wherein the film-forming polymer is water dispersible.

14. The method of claim 10, wherein the film-forming polymer is water dispersible.

15. The method of claim 10, wherein the composition further comprises a (meth)acrylate functional compound distinct from the polymer comprising acetoacetyl functionality.

16. The method of claim 15, wherein the composition is UV-curable.

17. A method comprising applying the composition of claim 1 to a substrate and allowing the composition to dry.

18. A coating on a substrate, wherein the coating is preparable by the method of claim 1.

19. The coating of claim 18, wherein the substrate is selected from wood products and wood-based products, gypsum board, and cellulose-based substrates.

20. A method comprising reducing emission of formaldehyde from or near a substrate by applying to the substrate a composition comprising:
an amino-functional compound selected from: (1) compounds with a primary amino functional group and a weight average molecular weight of less than about 1000 g/mol; (2) compounds with a secondary amino functional group; (3) compounds with a tertiary amino functional group; (4) compounds with a functional group comprising an amine complex; and combinations thereof; and
a film forming polymer.

21. The method of claim 20, wherein the film-forming polymer comprises an acetoacetyl functional group of the formula: 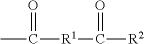
wherein R¹ is a C1 to C22 alkylene group and R² is a C1 to C22 alkyl group.

22. The method of claim 21, wherein R¹ is methylene (—CH₂—) and R² is methyl (—CH₃).

23. The method of claim 21, wherein the composition further comprises water.

24. The method of claim 21, wherein the composition further comprises a (meth)acrylate functional compound distinct from the polymer comprising acetoacetyl functionality.

25. The method of claim 24, wherein the composition is UV-curable.

26. A substrate comprising on a surface thereof a layer of a composition comprising an amino-functional compound selected from: (1) compounds with a primary amino functional group and a weight average molecular weight of less than about 1000 g/mol; (2) compounds with a secondary amino functional group; (3) compounds with a tertiary amino functional group; (4) compounds with a functional group comprising an amine complex; and combinations thereof.

27. The substrate of claim 26, wherein the substrate is selected from wood products and wood-based products.

28. The substrate of claim 27, wherein the wood product is a flooring material, a cabinet material, a furniture material, a wall panel or a roofing panel.

29. The substrate of claim 27, wherein wood-based product comprises an adhesive, and wherein the adhesive emits formaldehyde.

30. A method comprising reducing the concentration of formaldehyde in ambient air proximal a substrate by applying to an exposed surface of the substrate a composition comprising an amino-functional compound selected from: (1) compounds with a primary amino functional group and a weight average molecular weight of less than about 1000 g/mol; (2) compounds with a secondary amino functional group; (3) compounds with a tertiary amino functional group; (4) compounds with a functional group comprising an amine complex; and combinations thereof.

31. The method of claim 30, wherein the substrate is selected from wood products and wood-based products.
